(19) United States
(12) Patent Application Publication
(10) Pub. No.: US 2007/0021515 A1
(43) Pub. Date: Jan. 25, 2007

(54) Expandable starch-based beads and method of manufacturing molded articles therefrom

(75) Inventors: Gregory M. Glenn, American Canyon, CA (US); Simon K. Hodson, Santa Barbara, CA (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignees: United States (as represented by the Secretary of Agriculture); E. Khashoggi Industries, LLC, Santa Barbara, CA (US)

(21) Appl. No.: 11/184,614

(22) Filed: Jul. 19, 2005

(51) Int. Cl. C08J 9/00

(52) U.S. Cl. 521/99

(57) ABSTRACT

An expandable starch-based composition includes a starch, a volatile blowing agent, a non-volatile plasticizer, nucleating agent, and a water-resistant polymer. The expandable starch-based composition can be characterized by having a plasticized starch capable of expanding when rapidly heated to above the boiling point of the volatile blowing agent and the softening point of the plasticized starch. The composition can be used in a method of manufacturing an expandable starch-based bead, wherein the method includes: introducing the composition into an extruder; heating and mixing the composition in order to yield a thermoplastic melt; extruding the thermoplastic melt through a die opening to yield an extruded strand; cooling the extruded strand; and cutting the cooled strand in to beads. The beads can be used in a method of manufacturing a biodegradable article, the method includes: providing a plurality of expandable starch-based beads; placing the beads into a mold cavity; rapidly heating the beads to a temperature greater than the boiling point of the volatile blowing agent; causing at least a portion of the expanded beads to adhere together to form an intermediate molded body; and cooling the intermediate molded body to yield the article of manufacture.

### CROSS-REFERENCE TO RELATED APPLICATION

This United States Patent Application cross-references another United States Patent Application filed simultaneously herewith on Jul. 19, 2005, entitled “FIBER-REINFORCED STARCH-BASED COMPOSITIONS AND METHODS OF MANUFACTURE AND USE” with Gregory M. Glenn and Simon K. Hodson as inventors, attorney Docket No. 13207.104, Express Mail Label No. EV565665462US, the disclosure of which is incorporation herein in its entirety.

### BACKGROUND OF THE INVENTION

1. The Field of the Invention

The present invention relates generally to expandable starch-based beads. More particularly, the present invention relates to expandable starch-based bead compositions used to manufacture molded articles, methods of manufacturing starch-based beads, and methods of making molded articles therefrom.

2. The Related Technology

Many articles in commerce are designed and produced to be disposable after a single use. The most common materials in single-use articles are exemplified by paper, paperboard, plastics, polystyrenes, and metals. In part, the disposability of an item after a single use results from busy lifestyles that require instant or ready-made food and beverage containers. For example, one visit to a fast-food restaurant or convenience store can result in a single person using and discarding multiple disposable containers, some of which were only in use for less than five minutes or the time it takes to transport food from a grill to a serving tray. While these articles are typically discarded after a single use, or after the primary product has been removed from the article in the form of a container, the articles are often not biodegradable. Due to the overwhelming magnitude of non-biodegradable, single-use articles being produced and distributed, the final destinations of such articles (e.g., landfills) are quickly becoming oversaturated and incapable and/or insufficient for properly dealing with and/or destroying these articles.

As stated, one highly used material for the production of single-use items is polystyrene or polystyrene foams. Polystyrene foams and the articles manufactured therefrom are usually produced from expandable polystyrene (EPS) beads molded into the desired articles or shapes. More particularly, EPS beads containing some gas or volatile solvent are prepared and pre-expanded by heating the bead so that it increases in volume and decreases in density. In order to make a product, these pre-expanded beads are loaded into a mold cavity having a desired shape, where heated gas (e.g., water vapor at 110°C.) is then circulated throughout the mold cavity. The heat causes the pre-expanded EPS beads to further expand at ambient pressure until they fill the voids in the mold and come into contact with each other. The heat also causes the polystyrene beads to soften so that the expanding beads adhere to one another and form a structure having substantially the same dimensions as the mold with very little void space between the beads.

In response to the environmental problems associated with single-use and disposable articles, research has been conducted to find substitute materials that are biodegradable and environmentally friendly. For some reason, very few suitable substitute biodegradable materials have been found to replace the overly-used paper, paperboard, plastics, polystyrenes, and metals in single-use or disposable items. Specifically, a reasonable biodegradable material has yet to be produced that can adequately be substituted for EPS beads. Thus, there remains a need for a biodegradable substitute for EPS beads and EPS-based products.

Therefore, it would be advantageous to provide a biodegradable material that can be substituted for EPS beads, and preferably have similar handling and molding characteristics therewith. Moreover, it would be beneficial to have a renewable raw material that can be prepared in a manner similar to the preparation of EPS beads, and fabricated into articles that can be substituted for EPS-based products.

### BRIEF SUMMARY OF THE INVENTION

The present invention is drawn toward an expandable starch-based composition (i.e., a bead). Such a composition includes starch, a volatile blowing agent, a non-volatile plasticizer, a water-resistant polymer, and a nucleating agent. The expandable starch-based composition can be characterized by being thermoplastic and capable of expanding when rapidly heated to above the boiling point of the volatile blowing agent and the softening point of the plasticized starch. Preferably, the composition is in the form of an expandable bead.

Additionally, another embodiment of the present invention provides a method of manufacturing an expandable starch-based bead. Such a method includes an act of introducing the aforementioned components into an extruder. Additionally, the components are heated and mixed in order to yield a thermoplastic melt. The thermoplastic melt is extruded through a die opening to yield an extruded strand, which is then cooled. After the thermoplastic melt has cooled sufficiently, it is cut into pellets.

Another embodiment of the present invention includes a method of manufacturing an article from starch-based beads. The method includes the acts of providing a plurality of the aforementioned expandable starch-based beads; placing the beads into a mold cavity; rapidly heating the beads while in the mold cavity to increase the temperature of the beads so as to be greater than the boiling point of the volatile blowing agent and at or above the softening point of the starch in order to cause the beads to expand and increase in volume; adhering the expanding beads together to form an intermediate molded body; and cooling the intermediate molded body to solidify the expanded and self-adhered beads to yield the article of manufacture.

The resulting molded body is biodegradable. To protect it from moisture during storage and/or use it may advantageously be coated with an appropriate coating material. The coating material may comprise a biodegradable water-resistant polymer, hydrophobic polymer, or wax.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a schematic diagram illustrating an embodiment of a system for preparing starch-based beads;

FIG. 2 is a schematic diagram illustrating an embodiment of a system for pre-expanding starch-based beads;

FIG. 3 is a schematic diagram illustrating an embodiment of a molding system for preparing an article from expanded starch-based beads; and

FIG. 4 is a cross-sectional side view illustrating an article prepared from the molding system depicted in FIG. 3.

### DETAILED DESCRIPTION OF THE PREFERRED EMBODIMENTS

The present invention is drawn to starch-based bead compositions and methods of manufacture and use. The terminology employed herein is used for the purpose of describing particular embodiments only and is not intended to be limiting.

As used herein, the term “starch” is meant to include starches and derivatized starches that are capable of being used in the compositions described herein. Additionally, the term “gelatinous starch” is meant to characterize the starch and/or starch derivative being combined into a hydrated dispersion that has been heated and gelatinized. In any event, the starch can include a derivatized and/or gelatinized starch unless clearly indicated otherwise.

As used herein, the term “fluid” is meant to refer to a liquid and/or a gas. As such, a fluid is able to fill the volume of a container and flow freely through tubes or pipes.

As used herein, the term “dry weight” is meant to refer to the composition being characterized without the presence of a volatile blowing agent. For example, when the relative concentrations are expressed in percentages by dry weight, the relative concentrations are calculated as if there were no volatile blowing agent. Thus, the dry weight is exclusive of any volatile blowing agent such as water.

As used herein, the term “wet weight” is meant to refer to the composition being characterized by the moisture content that arises from the presence of the volatile blowing agent. For example, the relative concentration of the volatile blowing agent is measured by a total weight that includes the volatile blowing agent, which is thereby a wet weight.

As used herein, the term “thermoplastic” is meant to refer to the state of a composition that is capable of being hardened when the temperature is decreased and softened to the point of being malleable when the temperature is increased.

As used herein, the term “rapidly heating” is meant to refer to the rate at which the temperature of a composition increases. As such, rapidly heating refers to the process of exposing a composition to a heated environment or heating element so as to increase the temperature of the composition at a rate that induces expansion rather than drying.

As used herein, the term “mold gap” is meant to refer to the distance from one side of a mold body to the other side of the mold body. As such, the mold gap is the space between each side of a mold, wherein a mold cavity can have varying mold gap distances at different locations.

Concentrations, amounts, particles sizes and other numerical data may be presented in a range format. It is to be understood that such a range format is used merely for convenience and brevity and should be interpreted flexibly to include not only the numerical values explicitly recited as the limits of the ranges, but also to include all the individual numerical values or sub-ranges encompassed within that range as if each numerical value and sub-range is explicitly recited. For example, in one embodiment the starch can be present in various compositions within a range of from about 15% to about 95% by dry weight. This recited range should be interpreted to include not only the explicitly recited limits of about 50% and about 90%, but also to include such individual compositional percentages such as 55, 62, 70, and 88 as well as sub-ranges between these individual percentages. This interpretation should apply regardless of the breadth of the range or the characteristic being described, and should apply to ranges having both upper and lower numerical values as well as open-ended ranges reciting only one numerical value.

One embodiment of the present invention is a biodegradable composition that can be formed into pellets or beads for use in an expansion molding system. As such, the inventive composition includes a starch or starch derivative. Starch is a natural product that is obtained from potatoes, corn, waxy corn, tapioca, wheat, high-amylose starches, waxy starches, and other renewable plant sources. Chemically, starch is a polymer comprised of amylose and amylopectin, and is considered a polysaccharide material. In addition to being a natural product obtained from various renewable resources, starch is also biodegradable. Nevertheless, starch can be combined and processed with water, other polymers, or organic materials in order to have plasticized and thermoplastic characteristics. High amylose starches can include amylose at greater than 40%, greater than 50%, greater than 70%, or greater than 80%. On the other hand, waxy starches usually have less than 10% amylose with greater than 90% amylopectin. Additionally, starch can be used in a derivatized and/or gelatinized form.

Starch can be used in various amounts and ranges in order to be formed into an expandable bead, which can expand to many times its original volume. Also, the amount of starch is dependent on the types and amounts of other materials in the composition. For example, the amount of starch can range from about 15% to about 95% by weight of the dry components (i.e., exclusive of volatile agent) within the composition, more preferably about 40% to about 90%, and most preferably about 60% to about 80% by dry weight.

In one embodiment, other polysaccharides can be used in place of, or with, a starch or starch derivative. Many polysaccharides, such as cellulose and its associated derivatives, are chemically similar to starch. Examples of some polysaccharides that can be used include celluloses, inulins, chitins, chitosans, glycogens, pectins, hemicelluloses, glucomannans, galactoglucomannans, xyloglucans, methylglucuronoxylans, arabinoxylans, methylglucuronoarabinoxylans, glycosaminoglycans, chondroitins, hyaluronic acids, alginic acids and the like.

An embodiment of the present invention is a biodegradable composition that can be extruded into various shapes and forms for use in expansion, injection, and compression molding systems. As such, the inventive composition includes a starch and/or starch derivative. Also, starch can be gelatinized before or during the preparation of the inventive compositions. Gelatinized starches are typically produced from a starch-water dispersion that is mixed while being heated. After the dispersion reaches a certain temperature, starch granules begin to swell and structurally morph and transform into gelatinous starch. In comparison to starch, gelatinous starch is more susceptible to hydrolysis and enzymatic degradation, which leads to being more biodegradable. Additionally, gelatinized starches can impart higher viscosities to the compositions. A more detailed discussion of starch can be reviewed in the incorporated reference.

In any event, articles prepared from embodiments of the starch-based compositions can substantially degrade when exposed to non-optimal environmental conditions in less than about 5 years, more preferably less than about 3 years, even more preferably less than about 2 years, and most preferably less than about 1 year. Some articles made from different embodiments of the starch-based compositions can substantially degrade in optimal environmental conditions in less than about 10 months, more preferably less than about 8 months, even more preferably less than about 6 months, and most preferably less than about 3 months. Alternatively, articles made from different embodiments of the starch-based compositions can substantially degrade in optimal environmental conditions in less than about 8 weeks, more preferably less than about 6 weeks, and most preferably less than about 3 weeks.

An expandable composition in accordance with the present invention also includes a volatile solvent and/or blowing agent with relatively low vapor pressure and/or vaporization temperature that is a liquid at normal temperatures or ambient conditions. The volatile blowing agent is combined with the starch-based composition so that, when the composition is elevated to an appropriate temperature, the volatile blowing agent vaporizes into a gas. As this occurs, the starch-based composition “puffs” or expands from its initial volume to an expanded volume because of the change in volume or space occupied by the volatile blowing agent changing from a liquid to a gas.

The volatile blowing agent can be any of a variety of substances that vaporize from a liquid to a gas within the processing temperatures that range from about 80° C. to about 240° C. As such, examples of the volatile blowing agent can include water, acetone, methanol, ethanol, isopropyl alcohol, and the like. Additionally, it can be preferable to combine water with an additional blowing agent in order to modify the vaporization temperature (e.g., by forming lower boiling azeotropes) in order to control the rate and degree of expanding the starch-based beads. The volatile blowing agents are included within the starch-based beads in an effective amount that can allow for efficient expansion of beads up to many times the initial volume. For example, the volatile blowing agent can be present at a range of concentrations of from about 1% to about 30% by wet weight of the hydrated beads (i.e., inclusive of blowing agent), more preferably from about 8% to about 25%, and most preferably from about 10% to about 20% by wet weight.

Additionally, expandable starch-based compositions in accordance with the present invention include a non-volatile plasticizer. The inclusion of a non-volatile plasticizer can help soften the starch before and during the heating/expansion process. Additionally, after expansion and subsequent cooling and solidification of the expanded starch article, the plasticizer helps prevent the starch from becoming embrittled and forming retrograde recrystallization products. Also, the non-volatile plasticizers remain within the final foamed starch-based bead or article rather than being volatilized off during expansion. Examples of non-volatile plasticizers include polyalcohols (“polyols”) such as glycerin, sorbitol, mannitol, and the like, as well as other polyols (e.g., polyethylene glycol) that can plasticize starch. The non-volatile plasticizer can be included in the starch-based compositions in an amount sufficient to plasticize the starch so as to behave in a thermoplastic manner. For example, the non-volatile plasticizer can be included at a range of from about 1% to about 35% plasticizer by dry weight of the dry components (i.e., exclusive of volatile agent), more preferably from about 5% to about 35%, and most preferably from about 8% to about 25% by dry weight.

The starch-based compositions also include a water-resistant polymer. When combined with a starch-based composition, the water-resistant polymer can provide thermoplastic and plasticized characteristics. Similar with the plasticizer, the water-resistant polymer can increase the cohesiveness of individual starch-base beads and adhesion between multiple beads, especially during expansion and/or molding. The water-resistant polymer can aid in holding the water or other volatile blowing agent within the expandable bead in order for the bead to expand instead of prematurely drying out. In addition, the water-resistant polymer can increase long-term stability of the expanded beads as well as any articles made therefrom because of an increase in water-resistance and strength. Thus, the water-resistance provides a barrier to water permeation and resists large fluctuations in moisture contents within the expanded starch that can occur when the expanded beads or articles are exposed to various environmental conditions such as varying relative humidity.

Many water-resistant polymers are known in the art, and most can be used at varying concentrations. For example, the water-resistant polymer can include ethylene-vinyl alcohol copolymer (EVOH), ethylene-vinyl acetate copolymer (EVA), propylene-vinyl alcohol copolymer (PVOH), propylene-vinyl acetate copolymer, polyvinyl alcohol (PVA), partially hydrolyzed ethylene-vinyl acetate copolymer, propylene-vinyl alcohol, and the like. Additionally, the water-resistant polymers can include biodegradable polyesters such as, for example, poly(butylene succinate) (PBS), poy(butylene succinate-co-adipate) (PBSA) copolymers, poly(butyrate adipate terephthalate) (PBAT), adipic acid aliphatic/aromatic copolyesters (AAC), poly(lactic acid) (PLA), polycaprolactone (PCL), poly(hydroxy alkanoates) (PHAs) including poly-β-hydroxybutyrate (PHB) and its copolymer with hydroxyvaleric acid (PHB/v), modified polymers of polyterephthalate, poly(tetramethylene adipate-co-terephthalate) (i.e., Eastar Bio-GP™), Ecoflex™, Biomax™, and the like. Also, polymeric mixtures of the foregoing polymers can provide water-resistant and thermoplastic properties. Moreover, many waxes can be used to enhance the favorable properties imparted by the water-resistant polymers. In any event, the water-resistant polymer or wax can be present at a concentration of less than 75% by dry weight (i.e., exclusive of volatile agent), or range from about 3% to about 75% by dry weight of the dry components in the composition, more preferably from about 5% to about 50%, and most preferably from about 10% to about 25% by dry weight.

Additionally, it can be beneficial to combine a nucleating agent with the starch-based composition in order to enhance vaporization of the water or other volatile blowing agent. The nucleating agents provide a point for the formation of cells or cavities within the composition during expansion. Modulation of the type, amount, and distribution of the nucleating agent can be used to control the production of a larger number of small cells to result in a higher cell density for the expanded beads or foamed articles. On the other hand, the nucleating agents can be used to produce a smaller number of large cells.

Accordingly, various nucleating agents are known and used in the art, all of which may be used in the inventive compositions. The nucleating agents can include, for example, aromatic carboxylate salts, sodium benzoate, talc, calcium carbonate, silica, titania, sorbitol acetals, phosphate ester salts, organic and inorganic pigments, and other organic and inorganic particulates. For example, the starch-based compositions can include the nucleating agent at a concentration less than about 40% by dry weight of the dry components (i.e., exclusive of water), more preferably from about 1% to about 30%, even more preferably about 5% to about 25%, and most preferably from about 10% to about 15% by dry weight.

Another embodiment of the present invention includes fibers within the starch-based compositions in order to provide structural reinforcement to the expanded beads and articles made therefrom, as well as articles made from non-foamed compositions. Various types of fibers may be incorporated into the compositions of the present invention in order to obtain specific characteristics, and additional details can be reviewed in the incorporated reference.

In one embodiment, a starch-based composition includes a starch capable of being processed into a plasticized starch that behaves in a thermoplastic manner when heated to above a softening point of the plasticized starch. Additionally, the bead composition includes a volatile blowing agent mixed with the starch in an amount and distribution sufficient to be capable of expanding when heated above a boiling point of the volatile blowing agent. Also, a non-volatile plasticizer is mixed with the starch in an amount and distribution sufficient to form the plasticized starch. A water-resistant polymer is mixed with the plasticized starch in an amount and distribution sufficient so as to enable the plasticized starch to expand when heated to above the boiling point of the volatile blowing agent. Thus, the expandable starch-based bead composition can be characterized by being thermoplastic and capable of expanding when rapidly heated to above the boiling point of the volatile blowing agent and the softening point of the plasticized starch.

The expandable starch-based compositions are prepared by thoroughly mixing the aforementioned components, and optionally mixing additional components known to be combinable with expandable compositions such as waxes. While expanding, the beads can become tacky and adhere together, especially when expanded under steam. For example, the starch-based beads can be capable of expanding to at least about 2-times greater, more preferably at least about 5-times greater, even more preferably at least about 10-times greater, and most preferably at least about 25-times greater than the original volume.

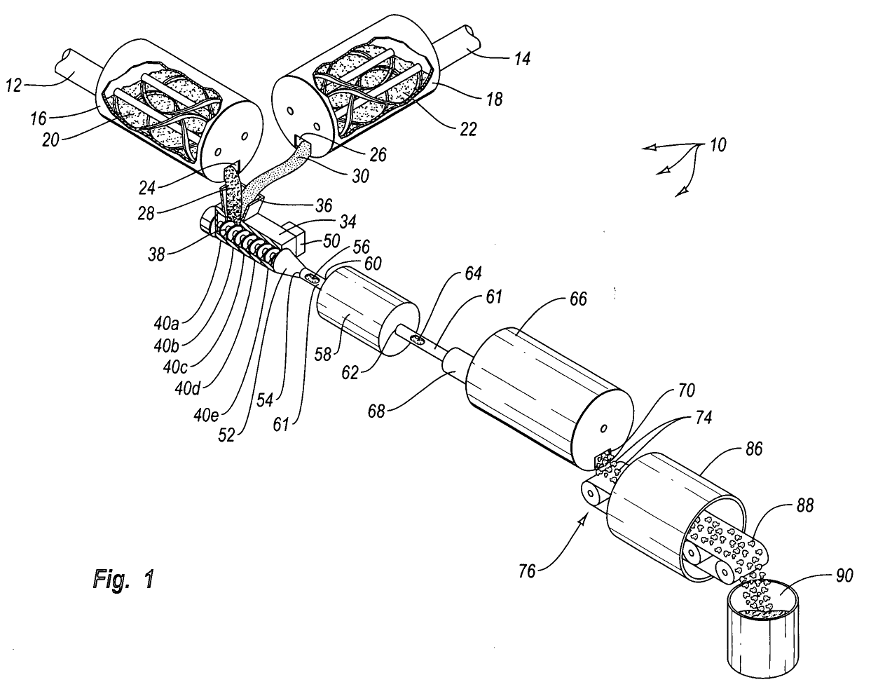

Accordingly, FIGS. 1-3 illustrate various schematic diagrams of embodiments of processing systems and equipment that can be used during the formation of a starch-based composition, bead, and/or article of manufacture. It should be recognized that these are only examples of schematic representations of processing systems and equipment, and various modifications can be made thereto in order to prepare the inventive compositions and articles of manufacture. Accordingly, the various systems and equipment currently known or later developed for preparing expandable compositions and forming articles therefrom are considered to be included within the scope of this disclosure. Also, the schematic representations should not be construed in any limiting manner to the arrangement, shape, size, orientation, or presence of any of the features described in connection therewith. With that said, a more detailed description of examples of some of the systems and equipment that can prepare the compositions as well as manufacture articles that are in accordance with the present invention is now provided, and additional examples can be reviewed in the incorporated reference.

Referring now to FIG. 1, which depicts a pelleting system 10 in accordance with the present invention. Such a pelleting system 10 includes a first mixer 16, optional second mixer 18, extruder 34, optional dryers 58, pelletizer 66, optional conveyer assembly 76, optional conditioning apparatus 86, and optional pellet collector 90.

The first mixer 16 is configured to receive at least one feed of materials through a first feed stream 12. The first mixer 16 processes the materials supplied by the first stream 12 into a first mixture 20. After adequate processing, the first mixture 20 is removed from the first mixer 16 via a first mixer outlet 24 as a first mixed stream 28. Similarly, the optional second mixer 18 has a second feed stream 14 that supplies the material to be mixed into a second mixture 22. Likewise, the second mixture 22 is removed from the second mixer 18 via a second mixer outlet 26 as a second mixed stream 30. The second mixer 18 is optional because the additional components mixed therein could be introduced and mixed in the first mixer 16.

Additionally, the extruder 34 includes an inlet 36, extruder screw 38, heating elements 40a-e, a control module 50, and a die head 52 with a die opening 54. Alternatively, the extruder can be any type of extruder, such as a single screw extruder, piston extruder, or a twin screw extruder as well as those with or without a heating element. Accordingly, both the first mixed stream 28 and the second mixed stream 30 are supplied into the extruder 34 through the inlet 36, wherein the extruder screw 38 mixes the feed to form a composition capable of being extruded. Additionally, while being mixed, the extruder screw 38 moves the composition longitudinally through the extruder 34 so as to pass by five heating elements 40a-e, although any number of heating elements may be employed. For example, the five heating elements 40a-e can be set to have a temperature gradient such as 80° C./95° C./110° C./115° C./95° C. This heating configuration can provide for a gradual increase in heating so as to avoid prematurely blowing off the volatile blowing agent. Alternatively, the heating elements 40a-e can be configured for temperature ramping, a parabolic temperature change, or the like, as well as for extrusion expansion, where the extrudate expands upon being extruded. In order to control the rate of mixing, extrusion, temperature distribution, and the like, the extruder 34 includes a control module 50.

As the composition moves to the end of the extruder 34, it passes through the die head 52 before being extruded through the die opening 54. Accordingly, the die head 52 can be tapered toward the die opening 54. The die head 52 and die opening 54 can be configured into any shape or arrangement so long as to produce a pelletable extrudate 56 that is capable of being expanded. When the extrudate leaves the opening, it can have a moisture content greater than about 30%, greater than about 25%, or greater than about 20%, any of which may be too moist for being pelletized. Thus, it can be beneficial to dry the extrudate before being pelletized

Alternatively, the extrudate can be partially expanded as it is extruded. This can result from a pressure differential from inside the extruder compared to the atmospheric pressure outside of the extruder. The expansion-extrusion can be enhanced by altering the shape of the die head, where an annular die opening can facilitate such an expansion to produce a hollow tubular extrudate.

The dryer 58 is optional because the extrudate can be stored in ambient or controlled conditions for a period of time in order to be properly dried rather than be processed through a dryer or for some other reason. When the dryer 58 is included, the extrudate 56 can be supplied into the inlet 60, dried, and removed from the outlet 62 through a pipe 61 or other transport means. The dried pellets can have a moisture content below about 20%, more preferably below 15%, and most preferably below about 10% before being pelletized.

In another embodiment, it can be beneficial to cool the extrudate after being extruded. As such, a cooler can be used in conjunction with, or in place of, the dryer 58. When the extrudate is processed through the die opening, it is in a heated and flowable or gummy state. As such, the extrudate can be cooled before being pelletized. For example, the extrudate can be cooled to a temperature of less than 35° C., more preferably a temperature less than 30° C., and most preferably less than 25° C.

After the extrudate 56 is dried, it is supplied to the pelletizer 66 into an inlet 68 through a pipe 61 and removed via an outlet 70. The pelletizer 66 can be configured for cutting the dried extrudate 64 into a variety of shapes and sizes. For example, the dried extrudate 64 can be cut into pellets 74 having a diameter range of from about 0.1 mm to about 1 cm, more preferably in a range of from about 0.2 mm to about 3 mm, and most preferably in a range of from about 0.3 mm to about 0.8 mm. In another embodiment, it can be preferable to have pellets with a diameter range of from about 0.2 cm to about 2 cm, more preferably in a range of from about 0.3 cm to about 1 cm, and most preferably in a range of from about 0.5 cm to about 0.8 cm diameter.

As such, the pellets 74 can be supplied from the pelletizer 66 to a conveyor assembly 76, as depicted or other means for carrying or transporting the pellets 74. The conveyor assembly 76 then transports the pellets 74 through an optional conditioning assembly 86, which can condition the pellets 74 for storage or further processing. This results in conditioned pellets 88 that can then be supplied to a pellet collector 90, or for further processing. For example, the conditioning assembly 86 can be configured to dry the pellets, apply a water-resistant coating such as a water-resistant polymer or a wax, and/or hydrate the pellets with water or volatile blowing agent. Alternatively, the conditioning assembly 86 can condition a molded article prepared from the pellets 74.

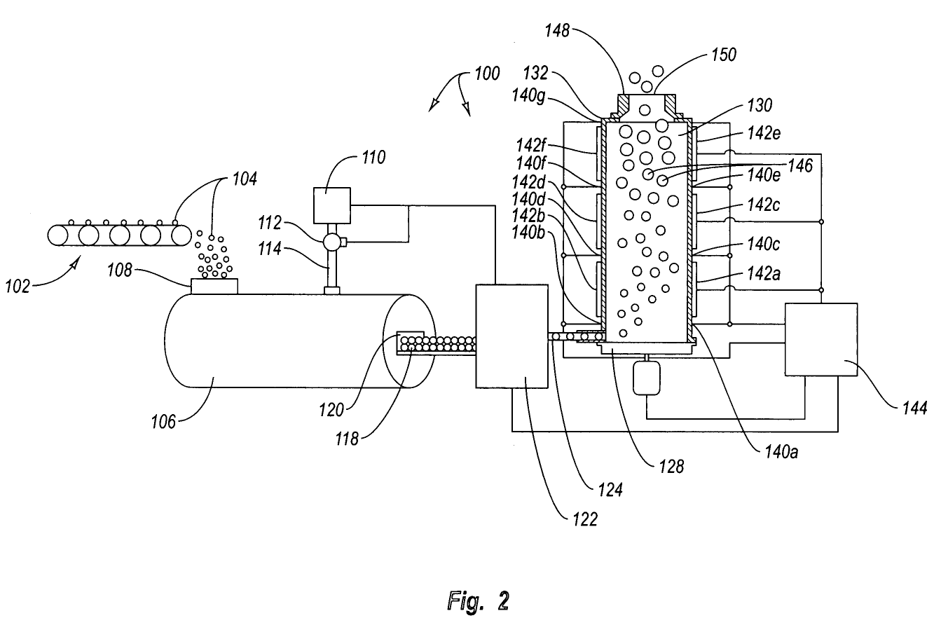

Referring now to FIG. 2, which illustrates an embodiment of a pre-expansion system 100. The pre-expansion system 100 is comprised of a conveyor assembly 102, hydration vessel 106, volatile solvent storage tank 110, and a pre-expansion vessel 128. The pre-expansion system 100 is configured to process starch-based pellets 104 (i.e., beads 104) in a manner that pre-expands the beads 104 so as to only partially expand the beads so that they can be further expanded in a later process. Alternatively, the pre-expansion system 100 can more fully expand the beads 104 for use in other types of processing or molding systems. The pre-expansion system 100 can provide expanded beads having an average diameter that can be used in pre-existing expansion molding equipment such as expandable polystyrene equipment.

The conveyor assembly 102 is configured to receive moist or dried beads 104 for transportation into the hydrating vessel 106 by being introduced into the vessel inlet 108. In order to hydrate the beads 104, the hydration vessel 106 can be fluidly coupled with a volatile agent storage tank 110 through a feed tube 114. Also, the feed tube 114 can include a flow valve 112 for metering and regulating the amount of volatile agent supplied into the hydration vessel 106.

After the beads 104 are sufficiently hydrated into hydrated beads 118, they are removed from the hydration vessel 106 via a vessel outlet 120. The hydrated beads 118 are then transferred into a feed control chamber 122. The feed control chamber 122 is coupled with the feed tube 124 that supplies the hydrated beads 118 into the pre-expansion vessel 128. Accordingly, the hydrated beads 104 can have moisture contents that range from about 5% to about 40% by wet weight, more preferably about 8% to about 25%, and most preferably from about 10% to about 20% by wet weight.

The pre-expansion vessel 128 includes a pre-expansion chamber 130 defined by a housing 132. Since FIG. 2 is only a schematic representation, the expansion chamber 130 can have any configuration and orientation now known or later developed for expanding hydrated beads of any composition. For example, the expansion chamber 130 can be a hot air fluidized bed that receives hydrated beads 118, which then are blown out as expanded beads 146.

In one embodiment, the pre-expansion vessel 128 includes a plurality of sensors 140a-g and heating elements 142a-f disposed along the length of the chamber 120. The plurality of sensors 140a-g can be configured to monitor the temperature and relative humidity at various locations on the wall of the chamber, and are in communication with a control module 144. Also, the control module 144 is in communication with heating elements 142a-f, which can be ports that supply hot air and/or steam into the chamber 130. For example, the control module 144 can regulate the temperature within the chamber 130 to be within a range of from about 80° C. to about 240° C., more preferably about 100° C. to about 210° C., and most preferably about 160° C. to about 190° C.

After traversing the length of the chamber 140, the beads 118 are “puffed” into pre-expanded beads 146. These pre-expanded beads 146 then move into the outlet head 148 region of the pre-expansion vessel 128. The outlet head 148 contains an opening 150 that serves to enable the pre-expanded beads 146 to be removed from the chamber 130. Accordingly, the pre-expansion vessel 128 can be configured for expanding starch-based beads 118 in accordance with the present invention. For example, each bead 118 can be partially expanded to a volume that is at least 1.5-times larger than its original volume, more preferably at least 2-times larger, and most preferably to at least 3-times larger.

In one embodiment, the hydrated beads 118 can be more fully expanded by the pre-expansion system 100. As such, the beads can be expanded to a volume that is about 2-times greater than their original volume, more preferably about 5-times greater, even more preferably at least about 10-times greater, or most preferably to at least about 25-times greater than their original volume. As such, the density of the expanded beads can decrease by about ½ of the original density, more preferably about ⅕ of the original density, even more preferably about 1/10 of the original density, and most preferably about 1/25 of the original density.

Additionally, the hydrated beads 118 can be expanded into expanded beads 146 so that each is characterized as a foamed bead that is much dryer than the hydrated beads 118. As such, the foamed beads can have a moisture content of about 3% to about 12%, more preferably about 4% to about 10%, and most preferably about 5% to about 8% moisture by weight. Accordingly, when the foamed beads are to be molded by hot air expansion, the beads may need to be re-hydrated or coated with a water-resistant polymer or wax, which can be done in a vessel similar with the re-hydration vessel 106 or conditioning assembly 86, as described herein. For example, the re-hydrated expanded beads can have a moisture content for further expansion of about 8% to about 25%, more preferably about 10% to about 20%, and most preferably about 12% to about 15% moisture by weight. The re-hydrated beads can be molded by compression, injection, or expansion molding.

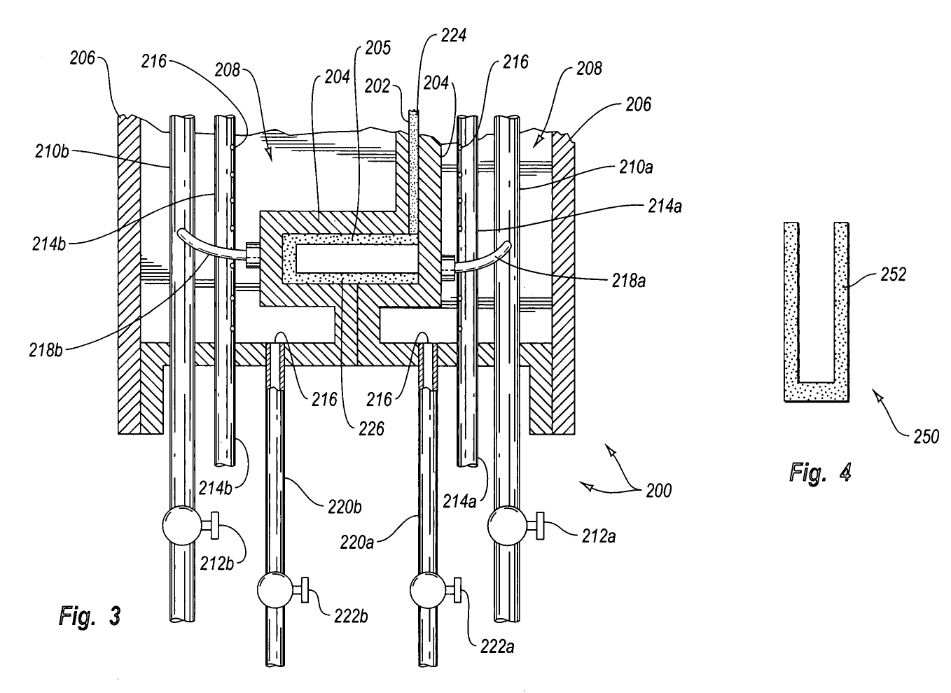

Referring now to FIG. 3, which illustrates an embodiment of an expansion molding system 200 in accordance with the present invention. The molding system 200 is comprised of a bead feed tube 202, mold body 204, housing 206, and heating components 210a-222b. As such the molding system 200 can be configured for manufacturing an article from pellets, hydrated beads, pre-expanded beads, or other bead described herein or in the incorporated reference.

The molding system 200 has a bead feed tube 202 that can receive non-expanded pellets, hydrated beads, pre-expanded beads, and even pre-expanded beads that have been dehydrated. For simplicity, any type of bead that is being supplied to the molding system 200 can be denoted as a bead 224. The feed tube 202 can extend through the mold body 204 in a manner that facilitates beads 224 being supplied into the mold cavity 205 in an amount and disposition to be properly molded. The mold body 204 can be in any shape and size as desired so that the molded article has substantially the same shape as the mold cavity 205.

Additionally, the mold body 204 can be disposed within a cavity 208 that is defined by a housing 206. In one embodiment, the cavity 208 can be configured to retain a fluid such as hot air, steam, or other heated fluid in contact with the mold body 204. This can provide a heat source to modulate the temperature of the mold body 204 as well as the mold cavity 205.

The housing 206 can be configured to receive various heat supplies such as steam tubes 210a-b, auxiliary heating tubes 214a-b, and hot air tubes 220a-b, where each is in thermal communication with the mold body 204 and the mold cavity 205. Each steam tube 210a-b and hot air tube 220a-b includes a valve 212a-b and 222a-b, respectively, that dynamically opens and closes so as to meter the amount of steam, hot air, or other heated fluid being supplied to the mold cavity 205 or cavity 208. The steam tubes 210a-b are each coupled to a steam channel 218a-b that transports the steam into the mold cavity 205. Additionally, the hot air tubes 220a-b and/or auxiliary heating tubes 214a-b can be in thermal communication with the mold cavity 205 or cavity 208 via ports or inlets 216. This allows for the heated medium to be circulated into the mold cavity 205 so as to contact the beads 224, and flow through the interstitial spaces between the beads 224 during the molding process.

Also, the steam can be removed from the mold cavity 205 through outlet ports (not shown). In one embodiment, the heating can include raising the temperature from normal ambient conditions to a temperature range of from about 80° C. to about 240° C., more preferably from about 100° C. to about 210° C., and most preferably from about 160° C. to about 190° C. However, other heating ranges can be used depending on the composition and hydration of the beads 224.

In operation, the expansion molding system 200 is configured to provide hot air, steam, or volatile agent from the various feed tubes into the mold cavity 205 in an amount and temperature sufficient to cause at least the outer surface of each bead 224 to become softened and pliable so that when the beads 224 expand in volume and come into contact with one another, the beads 224 are capable of sticking together. When the beads 224 stick together, they can adhere together to form an article comprised of the expansion molded beads 226 and gas. For example, the article can be comprised of gas from about 98% to about 50% by volume, or more preferably about 98% to about 70%, and most preferably about 95% to about 80% by volume. Additionally, the solid content of the bead material from about 2% to about 50% by volume, more preferably about 2% to about 30% and most preferably about 5% to about 20% by volume. However, other gas to solid bead material variations can be achieved.

In operation, the expansion molding system 200 can supply steam, hot air, and/or other volatile blowing agent to rapidly heat the beads 224 rather than a slow rate that tends to dry the beads. In one embodiment, the rate of heating can increase the temperature of the medium surrounding the beads to the aforementioned temperature ranges within 30 seconds, more preferable within 20 seconds, even more preferably about 10 seconds, and most preferably within 5 seconds. Alternatively, the heating can cause the beads to increase in temperature at a rate of about 10° C. per minute, more preferably about 50° C. per minute, and most preferably about 100° C. per minute, or faster.

In any event, the rate at which the beads are heated can be controlled by convection and conduction heating, where the heating medium can greatly alter the rate of heating and the amount of time it takes for expansion to initiate. As such, it is possible that after heating has initiated, the beads can begin to expand within about 30 seconds, more preferably about 15 seconds, and most preferably after about 5 seconds.

Additionally, the expansion molding system 200 can be configured so that the distance from one side of the mold body 204 to the other side is less than the diameter of a fully expanded bead. More particularly, each bead 224 can have a diameter that is about the same as the mold gap in order to provide equal heat transfer on both sides of the beads 224. In this way, the beads 224 will expand to fill the interstitial spaces between the beads 224 rather than growing to the size of the mold gap. This can cause the beads 224 to expand together and thereby fuse more completely while in a softened state to form the expansion molded beads 226.

Referring now to FIG. 4, which illustrates an expansion molded article 250 in accordance with the present invention. As such, the expansion molded article 250 was prepared with the expansion molding system 200 depicted in FIG. 3. In any event, the expansion molded article 250 is comprised of expanded beads 252, and can be in any moldable shape and/or size. For example, the article 250 can be a cup or any other article that is heretofore prepared by expandable polystyrene beads.

In one embodiment, a starch-based composition is a drop-in replacement for equipment designed for manufacturing articles such as food containers out of polystyrene. As such, the starch-based beads are saturated with a blowing agent (water), and pre-puffed in a large hopper/dryer that circulates hot air or steam around the beads until they expand to a large-enough volume to be forced out of the top of the hopper. After being pre-expanded, the puffed beads are conditioned in large bins for about 72 hrs with a volatile blowing agent. Additionally, the molds use hot air or steam in order to heat the molds and the pre-expanded beads inside. The heat causes the pre-expanded beads to expand further in size, and to become tacky and adhere together to form the molded articles. Thus, the starch-based compositions can be employed in equipment originally designed to be used with styrene-based beads.

In another embodiment, the water resistance of the beads and/or molded articles can be increased by applying a water-resistant film coating. Alternatively, including an increased amount of water-resistant polymer and/or wax can provide the water-proofing. This is because the water-resistant polymer or wax can migrate to the surface of the molded article due to the movement of superheated blowing agent outwardly toward the bead surface. As such, the film coating can be comprised of a water-resistant polymer, hydrophobic polymer, or wax.

The following examples are presented in order to more specifically teach the method of forming starch-based, expandable compositions that can be processed into articles of manufacture according to the present invention.

### EXAMPLES OF EMBODIMENTS OF THE INVENTION

### Example 1

### Expanded Biodegradable Starch Beads

Various starch-based compositions were prepared for processing into a bead om accordance with the present invention. The starch-based compositions were prepared by combining ethylene-vinyl alcohol copolymer (EVOH), glycerol, sorbitol, talc, dry starch, and water into a mixer and mixed under normal mixing conditions. The relative concentrations are provided in weight percent based on the dry weight in the absence of water, and the water concentration is based on the moisture content relative to the dry weight. The starch-based compositions were processed into beads and expanded in a hot-air hopper to form a “puffed” bead. After being expanded, each of the starch-based beads was assayed to determine the bulk densities (g/mL) with respect to the pre-puffed moisture content. The results of the moisture-density study are set forth in Table 1 as follows:

TABLE 1

| | | Glyc- | Sorbi- | | | | | Bulk |
|---|---|---|---|---|---|---|---|---|
| % | EVOH | erol | tol | Talc | Starch | Total | Water | Density |
| 1 | 5.16 | 12.28 | 10.32 | 0 | 72.24 | 100 | 15 | 0.39 |
| 2 | 5.16 | 12.28 | 15.48 | 1.55 | 65.53 | 100 | 10 | 0.54 |
| 3 | 5.11 | 8.10 | 5.11 | 4.08 | 77.6 | 100 | 15 | 0.11 |
| 4 | 5.05 | 4.01 | 15.16 | 4.04 | 71.74 | 100 | 10 | 0.35 |
| 5 | 5.05 | 4.01 | 5.05 | 0 | 85.89 | 100 | 20 | 0.08 |
| 6 | 10.10 | 4.01 | 15.16 | 0 | 70.73 | 100 | 15 | 0.29 |
| 7 | 10.32 | 12.28 | 5.16 | 0 | 72.24 | 100 | 10 | 0.37 |
| 8 | 10.21 | 8.10 | 15.32 | 1.53 | 64.84 | 100 | 20 | 0.34 |
| 9 | 10.21 | 8.10 | 10.21 | 4.08 | 67.39 | 100 | 20 | 0.21 |
| 10 | 10.32 | 12.28 | 15.48 | 4.13 | 57.79 | 100 | 15 | 0.45 |
| 11 | 10.10 | 4.01 | 10.10 | 1.52 | 74.27 | 100 | 10 | 0.19 |
| 12 | 15.16 | 4.01 | 5.05 | 1.52 | 74.27 | 100 | 15 | 0.10 |
| 13 | 15.32 | 8.10 | 15.32 | 0 | 61.27 | 100 | 10 | 0.50 |
| 14 | 15.16 | 4.01 | 10.10 | 4.04 | 66.69 | 100 | 10 | 0.21 |
| 15 | 15.48 | 12.28 | 15.48 | 4.13 | 52.63 | 100 | 20 | 0.36 |

As shown in Table 1, the bulk densities fluctuated with the different component concentration variations. More particularly, it can be seen that variations in the concentration of sorbitol and glycerol had the largest affect on the resulting bulk density. Also, the amount of water and/or talc and a smaller but significant negative relationship on the resulting bulk density. The EVOH content was shown to not have a significant effect on the bulk density in the range tested.

### Example 2

### Expanded Wheat, Corns and Potato Starch Beads

Starch-based beads were prepared with wheat, corn, and potato starches using the method and components described in Example 1. Accordingly, wheat starch (Midsol 50®; Midwest Grain Products; Topeka, Kans.), potato starch (Penford Food Products; Fort Collins, Colo.), and corn starch (Melojel®; National Starch and Chemical Company; Bridgewater, N.J.) were all obtained and prepared for being processed into a starch-based bead in order to compare the characteristics resulting from different starch sources. Additionally, an ethylene-vinyl alcohol copolymer resin (EVAL E105; EVALCA; Houston, Tex.) was obtained and similarly prepared. Briefly, the components for each mix design were combined and mixed into a composition capable of being expanded.

The resulting compositions were then introduced into a Leistriz co-rotating twin-screw extruder (Model MIC 18/GL 30D, Nurnberg, Germany). The extruder contained five heating zones and was equipped with a twin rod die with orifices 2 mm in diameter. The five heating zones allowed for the barrel temperature profile to be set at 75° C., 95° C., 110° C., 105° C., and 100° C. The screws had two sections of kneading blocks separated by conveying elements. The dry starch-based compositions were fed into the extruder at a constant rate of 12 g/min, and a water/glycerol mixture was metered directly into the feeding section along with the dry starch at a rate of 5.5 g/m.

After the starch-based compositions were mixed within the extruder and then extruded, the extrudate was collected as 80 cm rods. The extrudate rods were stored overnight in plastic bags and allowed to partially dry. The extrudate rods were then fed into a micropelletizer (Model 1; Wayne Machine and Die Co.; Totowa, N.J.) and pelletized into pellets having an average diameter of about 2 mm. The pellets were collected and dried overnight in an oven set at 55° C., and then re-hydrated to have moisture contents of 10%, 15%, 20%, and 25% before being expanded.

The re-hydrated pellets were then introduced into a hot air fluidized bed operated to produce a stream of hot air at about 190° C. to about 200° C. More particularly, batches of about 20 grams of re-hydrated pellets were introduced into the pre-heated hot air fluidized bed and rapidly heated for 1 minute. The re-hydrated pellets were puffed to expand the volume and decrease the bulk density, and then collected, cooled to room temperature, and stored in plastic re-sealable bags.

### Example 3

### -Bulk Density Analysis

The expanded starch-based beads prepared as described in Example 2 were studied to determine the bulk density variations. More particularly, the potato, wheat and corn starch-based expanded beads were studied in order to find the expanded bulk densities of the different starch sources as a function of moisture content (MC). A ten gram sample of each type of expanded bead was introduced into a 250 mL graduated cylinder. The volume for each sample was determined in triplicate, and converted into a bulk density (g/mL). The effect of variations in moisture content for each type of starch were analyzed, as presented in Table 2 as follows:

TABLE 2

| MC (%) | Potato (g/mL) | Wheat (g/mL) | Corn (g/mL) |
|---|---|---|---|
| 10 | 0.17 | 0.11 | 0.21 |
| 15 | 0.12 | 0.10 | 0.20 |
| 20 | 0.099 | 0.12 | 0.20 |
| 25 | 0.13 | 0.15 | 0.22 |

As shown in Table 2, the bulk density of the expanded beads prepared with potato starch generally decreased when the moisture content increased from 10% to about 20%, and then increased with an increase to about 25%. On the other hand, the bulk density of the expanded beads prepared with wheat starch showed an increasing trend that corresponded with the increasing moisture content. Additionally, the expanded beads prepared from corn starch did not show a significant increase or decrease in bulk density over the studied moisture content range; however, the corn starch beads had a higher bulk density at each moisture content percent compared to both the potato and wheat starch beads.

### Example 4

### Effect of Water-Resistant Polymers on Bulk Densities

Compositions having different types of water-resistant polymers were prepared in accordance with the process described in Example 3. More particularly, the potato, wheat, and corn starch-based compositions were prepared with either ethylene-vinyl alcohol copolymer (EVOH) or propylene-vinyl alcohol copolymer (PVOH). As such, each composition was prepared to include starch at 85.5% by dry weight (i.e., without water), water-resistant polymer at 5.2% by dry weight, sorbitol at 5.2% dry weight, and glycerol at 4.1% dry weight. Briefly, the samples were then dried and pelletized before being re-hydrated to have moisture contents of about 10%, 15%, 20%, and 25%. The rehydrated pellets were puffed in a hot air fluidized bed as in Example 2 having a temperature of about 200° C. and measured for bulk density as in Example 3.

The expanded beads prepared with EVOH and PVOH were compared to the results obtained in Example 3, which was considered to be the control. The bulk density obtained at the different moisture contents were then used to calculate an average bulk density over the moisture range. The results of the different types of water-resistant polymers on bulk density is shown in Table 3 as follows:

TABLE 3

| | Potato (g/mL) | Wheat (g/mL) | Corn (g/mL) |
|---|---|---|---|
| Control | 0.13 | 0.12 | 0.21 |
| PVOH | 0.285 | 0.37 | 0.42 |
| EVOH | 0.14 | 0.17 | 0.25 |

As shown in Table 3, the expanded beads prepared with corn starch had a higher bulk density than the expanded beads made of wheat or potato starches. Additionally, the PVOH roughly doubled the bulk density of the expanded beads regardless of starch type. The bulk density of potato starch was not significantly increased by addition of 5.2% EVOH compared to the control, but was significant for the wheat and corn expanded beads.

### Example 5

### Effect of Plasticizers on Expansion Temperature

Starch-based beads prepared from potato starch with varying types of plasticizers were prepared in accordance with Example 2. The compositions were varied to have 10% glycerol, 10% sorbitol, or a mix of 5% glycerol and 5% sorbitol (10% mixture). The expandable beads were then studied to determine the temperature at which expansion initiates. The expandable beads were conditioned to have a moisture content of 10%, 15%, 20%, and 25%, and analyzed with a thermo-mechanical analysis (TMA) module (Model 2920; TA Instruments; New Castle, Del.). The heating rate was set to increase the temperature of each bead at about 10° C. per minute. The expansion temperature was then compared for the different compositions as set forth in Table 4 as follows:

TABLE 4

MC (%)

| | 10% | 15% | 20% | 25% |
|---|---|---|---|---|
| No plasticizer | 163° C. | — | — | 140° C. |
| Glycerol | 171° C. | — | — | 135° C. |
| Sorbitol | 163° C. | — | — | 136° C. |
| Mix | 173° C. | 156° C. | 144° C. | 137° C. |

As shown in Table 4, changing the type of plasticizer can result in different expansion temperatures. Additionally, an increase in water content was shown to decrease the expansion temperature.

### Example 6

### Effect of EVOH Concentration on Expansion Temperature

Starch-based beads prepared from potato starch with varying amounts of ethylene-vinyl alcohol (EVOH) were prepared in accordance with Example 2. The compositions were varied to have 5%, 15%, or 30% EVOH and a moisture content of 10%, 15%, 20%, and 25%. The compositions were studied to determine the effect of EVOH concentration on the expansion temperate, as described in Example 5. The expansion temperature was then compared for the different compositions as set forth in Table 5 as follows:

TABLE 5

MC (%)

| | 10% | 15% | 20% | 25% |
|---|---|---|---|---|
| 5% EVOH | 170° C. | — | — | 137° C. |
| 15% EVOH | 164° C. | — | — | 131° C. |
| 30% EVOH | 156° C. | — | — | 128° C. |

As shown in Table 5, increasing the amount of EVOH and/or the moisture content can decrease the expansion temperatures for potato starch-based beads.

### Example 7

### Compositional Effects on Bulk Density

The compositional effects on bulk density were studied in the beads prepared in Examples 4 and 5. More specifically, the moisture content, plasticizer, and concentration of EVOH were varied, and the bulk density of each composition was determined as in Example 3. The bulk densities obtained by modulating the concentration of the compositional components is set forth in Table 6 as follows:

TABLE 6

MC (%)

| | 10% | 15% | 20% | 25% |
|---|---|---|---|---|
| Control | 0.155 | 0.169 | 0.183 | 0.177 |
| Glycerin 10% | 0.126 | 0.118 | 0.115 | 0.103 |
| Sorbitol 10% | 0.15 | 0.122 | 0.098 | 0.07 |
| EVOH 15% | 0.223 | 0.161 | 0.128 | 0.127 |
| EVOH 30% | 0.324 | 0.28 | 0.256 | 0.264 |

As shown in Table 6, the water content does not have a large effect on the expansion of potato starch beads that do not contain any plasticizers. On the other hand, by adding plasticizers the samples expanded to produce lower bulk density values. Additionally, the expanded beads made of 15% EVOH significantly decreased in bulk density as the moisture content increased. In comparison to the bulk densities obtained for 15% EVOH beads, the beads containing 30% EVOH had a higher bulk density.

### Example 7

### Moisture Sensitivity of Expanded Beads

Expanded beads having varied concentrations of ethylene-vinyl alcohol (EVOH) were studied to determine whether such a variation affected resistance to humidity and water. As such, starch-based beads having compositions that had 0% EVOH, 15% EVOH, and 30% EVOH were placed into environments with different moisture conditions to determine the amount of water absorption. The different environments included 50% relative humidity (RH) and 80% RH for 72 hours, and completely immersing the expanded beads in water for 1 hour. The expanded beads were weighed to determine the initial weight and then placed into the different environments before being tested to determine the end weight. After which, the percentage of moisture increase was determined for each type of bead, which are shown in Table 7 as follows:

TABLE 7

| | Environment | | |
|---|---|---|---|
| | RH 50% | RH 80% | Immersed |
| 0% EVOH | 8.84 | 14.1 | 244.4 |
| 15% EVOH | 7.14 | 13.8 | 146.3 |
| 30% EVOH | 5.58 | 12.3 | 85.6 |

As shown in Table 7, in each of the environments the expanded beads prepared without any EVOH showed the largest increases in moisture content. Also, by increasing the amount of EVOH, the moisture content decreased. Additionally, each of the bead compositions increased in moisture content by being progressively placed into increasingly moist environments, where being immersed into water showed the largest increase.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An expandable starch-based composition, the composition comprising:
starch having been plasticized and processed in order to behave in a thermoplastic manner when heated to above the softening point of the plasticized starch;
a volatile blowing agent comprising water;
a nucleating agent in an amount and distribution sufficient to provide a nucleus for vaporization of the volatile blowing agent;
a non-volatile plasticizer mixed with the starch in an amount and distribution so as to form the plasticized starch; and
a water-resistant polymer mixed with the starch in an amount and distribution sufficient for the plasticized starch to expand when heated to above the softening point of the plasticized starch and boiling point of the volatile blowing agent,
the expandable starch-based composition being characterized by being capable of behaving in a thermoplastic manner and expanding to a volume that is at least 2-times larger than its original volume when rapidly heated to a temperature above the softening point of the plasticized starch and above the boiling point of the volatile blowing agent.

2. A composition as in claim 1, wherein the plasticized composition is characterized by:
the starch being derived from source selected from the group comprised of potato, corn, tapioca, wheat, high amylose starch, waxy starch, and combinations thereof and present at a concentration in a range of about 15% to about 95% by dry weight in the absence of the volatile blowing agent;
the non-volatile plasticizer being selected from the group comprised of a polyol, glycerin, sorbitol, and combinations thereof and present at a concentration in a range of about 1% to about 35% by dry weight in the absence of the volatile blowing agent;
the water-resistant polymer being selected from the group comprised of poly(ethylene-vinyl alcohol), poly(ethylene-vinyl acetate), poly(vinyl alcohol), poly(butylene succinate), poy(butylene succinate-co-adipate), poly(butyrate adipate terephthalate), adipic acid aliphatic/aromatic copolyesters, poly(lactic acid), polycaprolactone, poly(hydroxy alkanoates), poly-β-hydroxybutyrate, poly(β-hydroxybutyrate-co-hydroxyvaleric acid), polyterephthalate derivatives, poly(tetramethylene adipate-co-terephthalate), and combinations thereof and present at a concentration in a range of about 3% to about 75% by dry weight in the absence of the volatile blowing agent; and
the nucleating agent being selected from the group comprised of an inorganic particulate, talc, calcium carbonate, silica, titania, and combinations thereof and present at a concentration less than about 40% by dry weight in the absence of the volatile blowing agent; and
the blowing agent is present at a concentration in a range of about 1% to about 30% by wet weight.

3. A composition as in claim 2, wherein the volatile blowing agent further comprises a component selected from the group comprised of acetone, methanol, ethanol, isopropanol, and combinations thereof.

4. A composition as in claim 2, further comprising at least one of a fiber or a wax.

5. A composition as in claim 1, wherein the temperature is within a range of from about 100° C. to about 240° C.

6. A composition as in claim 5, wherein the original diameter is within a range of from about 0.2 mm to about 1 cm.

7. A composition as in claim 5, wherein the expanded volume is at least 5-times larger than its original volume.

8. A composition as in claim 7, wherein the expanded volume is at least 25-times larger than its original volume.

9. A composition as in claim 1, further comprising a water-resistant film coating, the film coating being comprised of a water-resistant polymer or a wax.

10. A method of manufacturing an expandable starch-based bead, the method comprising:
introducing starch, a volatile blowing agent, a non-volatile plasticizer, a nucleating agent, and a water-resistant polymer into an extruder to form a mixture;
heating and mixing the mixture in order to yield a thermoplastic melt;
extruding the thermoplastic melt through a die opening to yield an extruded strand;
cooling the extruded strand; and
cutting the cooled strand into expandable beads that are characterized as being able to expand to a volume at least about 2-times greater than their original volume.

11. A method as in claim 10, wherein the method further comprises pre-mixing the starch and water-resistant polymer in a mixer separately from the volatile blowing agent and non-volatile plasticizer before the introducing.

12. A method as in claim 10, wherein the beads have an initial diameter within a range of from about 0.2 mm to about 1 cm.

13. A method as in claim 12, wherein the method further comprises drying the extrudate prior to being cut into beads, wherein the dried extrudate has a moisture content below about 20% by wet weight.

14. A method as in claim 13, wherein the extruding at least partially expands extrudate.

15. A method as in claim 13, wherein the method further comprises hydrating the beads to a moisture content ranging from about 5% to about 25%.

16. A method of manufacturing an article from starch-based beads, the method comprising:
providing a plurality of expandable starch-based beads that expand and adhere to each other upon being rapidly heated, the beads including starch, a volatile blowing agent, a non-volatile plasticizer, a nucleating agent, and a water-resistant polymer;
placing the expandable starch-based beads into a mold cavity;
rapidly heating the beads while in the mold cavity to a temperature greater than the boiling point of the volatile blowing agent and softening point of the beads in order to cause the beads to expand in size;
adhering at least a portion of the expanded beads together to form an intermediate molded body; and
cooling the intermediate molded body to yield the article of manufacture.

17. A method as in claim 16, wherein the temperature is within a range of from about 80° C. to about 240° C.

18. A method as in claim 17, wherein the rapidly heating includes passing one of steam or hot air through the mold cavity so as to contact at least a portion of the plurality of expandable starch-based beads and increase the temperature of the portion of beads so that expansion can be initiated within about 30 seconds.

19. A method as in claim 18, wherein the expansion is initiated within 15 seconds.

20. A method as in claim 18, wherein the beads have an initial diameter within a range of from about 0.2 mm to about 1 cm.

21. A method as in claim 18, wherein the at least a portion of the plurality of expandable starch-based beads have a diameter substantially the same as a mold gap.

22. A method as in claim 19, wherein at least a portion of the plurality of expandable starch-based beads have been pre-expanded to a volume that is at least 2-times larger than its original volume prior to being introduced into the mold cavity.

23. A method as in claim 18, wherein the method further comprises coating at least a portion of the article with a water-resistant film coating comprised of one of a water-resistant polymer or a wax.

24. An article of manufacture prepared by the method as in claim 18, the article comprising:
a plurality of expanded starch-based beads adhered together to form a body; and
a water-resistant film coating on at least a portion of the body.
